(19) United States
(12) Patent Application Publication
(10) Pub. No.: US 2015/0221177 A1
(43) Pub. Date: Aug. 6, 2015

(54) WAGERING GAME SYSTEMS AND METHODS FOR LIVE SPORTING EVENTS

(71) Applicant: Contagious Sports Ltd., London (GB)

(72) Inventor: Peter Glancy, London (GB)

(73) Assignee: Contagious Sports Ltd., London (GB)

(21) Appl. No.: 14/170,962

(22) Filed: Feb. 3, 2014

(51) Int. Cl. G07F 17/32

(52) U.S. Cl. CPC G07F 17/3288

(57) ABSTRACT

A system for providing a wagering game to a user via a computing device is described herein. The system includes a database including information associated with a live sporting event and a controller coupled in communication with the database and the computing device. The controller is configured to display at least one wagering opportunity on the computing device. The at least one wagering opportunity being indicative of an event outcome occurring in the live sporting event in the future within a particular event time period of the live sporting event. The controller receives a wager request to place a wager from a participating user. The wager being associated with at least one selected event outcome and event time period in which the selected event outcome will occur and responsively generates the wager.

### CROSS REFERENCE TO RELATED APPLICATION

This application claims the benefit of U.S. Provisional Patent Application Ser. No. 61/459,964, filed Feb. 1, 2013, the disclosure of which is hereby incorporated by reference in its entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The present invention relates to systems and methods of providing and conducting wagering games. In particular, the invention relates to systems and methods for providing and conducting wagering games which are integrated with live sporting events or other activities to permit wagering on the timing of outcomes that may occur during the event.

### BACKGROUND OF THE INVENTION

Sports betting has become a popular activity at casinos and sportsbooks by allowing a person to place wagers on the final outcomes of sporting events thus increasing a person's interest in the outcome and enjoyment of watching the sporting event. Accordingly, some sportsbooks include betting systems that enable a user to place wagers via a kiosk located within the sportsbook or located within the casino. For example, many sportsbooks allow users to place wagers that depend on the final outcome of one or more sporting events and may display lists of parlay wagers that are offered by the sportsbook. At least some known sportsbooks point-spreads and/or winning odds associated with various outcomes of sporting events and allows user to place wagers on the outcomes and the odds of associated with the outcome. Overtime, user may become frustrated and confused when placing wagers on sporting events because the odds and/or point spreads associated with the outcomes may change over time.

Players are attracted to the challenges offered by new wagering opportunities and may become frustrated at the limited number of wagers available. Likewise, sportsbooks desire new wagering opportunities to appeal to their player customers and entice players to place additional wagers. Accordingly, there is a continued need for systems and methods that create, provide and facilitate new and interesting sporting event wagers. In addition, a system that generates and displays simplified betting opportunities is desired to allow a user to easily understand and view the wager being placed.

### SUMMARY OF THE INVENTION

The invention relates generally to systems and methods of providing a wagering game based on events live sporting events which provides for time-based wagering opportunities before and during the event.

Some embodiments of the invention are directed to systems and methods for providing a wagering game that involves displaying one or more wagering opportunities that a specific outcome will occur in a live sporting event in the future within a particular time period of the live sporting event; receiving a wager associated with a selected specific outcome and time period in which the selected specific outcome will occur; receiving information regarding the selected time period of the live sporting event; determining if the selected specific outcome occurred during the selected time period; and settling the wager received from the participating player by either awarding a payout amount if the selected specific outcome occurred during the selected time period or collecting the wager.

In some embodiments, the time periods are uniform periods of time evenly distributed throughout the live sporting event. In some embodiments, the specific outcome may include the scoring of one or more points by one or more players or teams involved in the live sporting event.

Some embodiments of the invention are directed to systems that include one or more communication devices configured for displaying wagering opportunities, transmitting wager selections and receiving information regarding the selected time period of the live sporting event; and one or more processors configured for: determining if the selected specific outcome occurred during the selected time period; and settling the wager received from the participating player by either awarding a payout amount if the selected specific outcome occurred during the selected time period or collecting the wager.

The system may further include one or more display devices. The one or more processors, display devices and communication devices may be mounted in a single electronic platform or mounted independently from each other in remote locations. In some embodiments, the communication devices transmit information via a global telecommunication and/or computing network.

Some embodiments of the invention are also directed to a non-transitory machine readable media for providing a wagering game discussed herein, and in the accompanying materials, and may include one or more software programs, code and/or data segments as necessary to provide any of the methods described herein on one or more machines or to facilitate the installation and operation of such methods in systems described herein.

In one aspect of the present invention a system for providing a wagering game to a user via a computing device is provided. The system includes a database including information associated with a live sporting event and a controller coupled in communication with the database and the computing device. The controller is configured to display at least one wagering opportunity on the computing device. The at least one wagering opportunity being indicative of an event outcome occurring in the live sporting event in the future within a particular event time period of the live sporting event. The controller receives a wager request to place a wager from a participating user. The wager being associated with at least one selected event outcome and event time period in which the selected event outcome will occur. The controller responsively generates the wager, receives information regarding the selected event time period of the live sporting event, determines if the at least one selected event outcome occurred during the selected event time period, and settles the wager received from the participating player by either awarding a payout amount if the selected event outcome occurred during the selected event time period or collecting the wager.

In another aspect of the present invention, a method for providing a wagering game to a user. The method includes displaying at least one wagering opportunity on a computing device. The at least one wagering opportunity being indicative of an event outcome occurring in the live sporting event in the future within a particular event time period of the live sporting event. A wager request to place a wager is received from a participating user. The wager being associated with at least one selected event outcome and event time period in which the selected event outcome will occur. The method includes responsively generating the wager, receiving information regarding the selected event time period of the live sporting event, determining if the at least one selected event outcome occurred during the selected event time period, and settling the wager received from the participating player by either awarding a payout amount if the selected event outcome occurred during the selected event time period or collecting the wager.

In yet another aspect of the present invention, one or more non-transitory computer-readable storage media, having computer-executable instructions embodied thereon is provided. The computer-executable instructions cause the processor to display at least one wagering opportunity on a computing device. The at least one wagering opportunity being indicative of an event outcome occurring in the live sporting event in the future within a particular event time period of the live sporting event. The processor receives a wager request to place a wager from a participating user. The wager being associated with at least one selected event outcome and event time period in which the selected event outcome will occur. The processor responsively generates the wager, receives information regarding the selected event time period of the live sporting event, determines if the at least one selected event outcome occurred during the selected event time period, and settles the wager received from the participating player by either awarding a payout amount if the selected event outcome occurred during the selected event time period or collecting the wager.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system for allowing a player to place wagers on a live sporting event via a user computing device, according to an embodiment of the invention;

FIG. 2 is schematic view of a betting controller that may be used with the system shown in FIG. 1;

FIG. 3 is a flowchart of a method that may be used with the system shown in FIG. 1 for allowing a player to place wagers on a live sporting event, according to an embodiment of the invention; and

FIGS. 4 and 5 are exemplary entertaining graphical displays of a betting screen that may be used with the method shown in FIG. 3, according to an embodiment of the present invention.

Corresponding reference characters indicate corresponding parts throughout the drawings.

### DETAILED DESCRIPTION OF THE PREFERRED EMBODIMENT

With reference to the drawings and in operation, the invention overcomes at least some of the disadvantages of known betting systems by providing, among other things, systems and methods that enable a player to place a wager during a live sporting event. In addition, the system and methods of the invention may allow a player to place wagers on intermediate outcomes of a live sporting game that occur during the play of the game. For example, the system may allow a player to place a wager on the number of goals that will be scored by a participating team and the time period during the game in which the team will score the goals. Moreover, the system enables a player to place wagers these wagers as the game is being played and may allow a player to place a wager on a specific goal to be scored moments during the game and moments before the goal may be scored. For example, the system may allow a player to place a wager during a live game that includes a team scoring a goal within 20 seconds of the wager being placed. By allowing a player to place in-game wagers on live sporting events, the player's interest and excitement in the sporting events associated with the wager is increased. Thus, the amount of wagers made by the player is increased.

As used herein, the term “wagering opportunity” is any event that includes an outcome and a wager type associated with the event outcome. For example, in some embodiments, a wagering opportunity may include, but is not limited to, a specific event outcome occurring in the live sporting event in the future within a particular event time period of the live sporting event. For example, in one embodiment, a wagering opportunity may include a goal being scored in a Football match with a predefined period of time such as, for example, between the 5^{th} minute and the 10^{th} minute of the first half, a goal being scored in a hockey game between the 15^{th} and 20^{th} minute of the 3^{rd} period, and/or a touchdown being scored in an American football game between the 10^{th} and 12^{th} minute of the 2^{nd} quarter. In addition, in one embodiment, a wagering opportunity may include a foul being called being called between the 5^{th} minute and the 10^{th} minute of the 2^{nd} half of a football game, and/or a yellow/red card being issued between the 40^{th} and 45^{th} minute of the 2^{nd} half of the game. Many variations of a wagering opportunity that includes a specific event outcome occurring in the live sporting event in the future within a particular event time period of the live sporting event are within the scope of the present invention.

In general, the system 10 receives a request from a player via a mobile computing device to place a wager on a live sporting event and responsively displays a plurality of wagering opportunities associated with the live sporting event on the mobile computing device. More specifically, the system 10 retrieves information associated with the sporting event including, but not limited to, the duration of the sporting event, the current progress of the sporting event, and/or the teams participating in the sporting event, and generates the plurality of wagering opportunities as a function of the event information, and allows the player to select one or more wagering opportunities on which to place the wager. For example, the system 10 may determine an event timeline as a function of the duration of the sporting event, generate a plurality of event time periods as function of the event timeline, and assign a specific event outcome to each of the event time periods. For example, if the specific event outcome is a goal, the system 10 may generate each wagering opportunity to include a goal being scored in a corresponding event time period.

In one embodiment, the system 10 may generate and display a plurality of betting slots associated with each wagering opportunity and allow the player to select one or more betting slots to be included in the wager. For example, the player may wager that four goals will be scored during a live football match and select four betting slots corresponding to each separate period of time along the event timeline at which each goal will be scored. The system 10 may monitor the live sporting event as the live sporting event is being played, and provides a payout to the player four goals were scored during the event and within the selected event time periods. In addition, the system 10 may generate betting slots associated with each participating team to allow the player to select the team and the period in which the selected team will score the goal.

In one embodiment, the system 10 may generate a plurality of wagering pools including each wagering pool being associated with a predefine number of wagering opportunities. For example, in one embodiment, the system 10 may generate a 4-event wagering pool that includes wagers that include 4 event outcomes, e.g. four goals. The system 10 allows a player to select the 4-event wagering pool and place a wager that includes selecting four betting slots indicative of each of the four goals. The system 10 may also generate a total payout award associated with the 4-event wagering pool determined as a function of each received wager that is associated with the 4-event wagering pool. By generating a displaying the betting slots, the ease in which the player can identify and select a descried wagering opportunity is increased.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

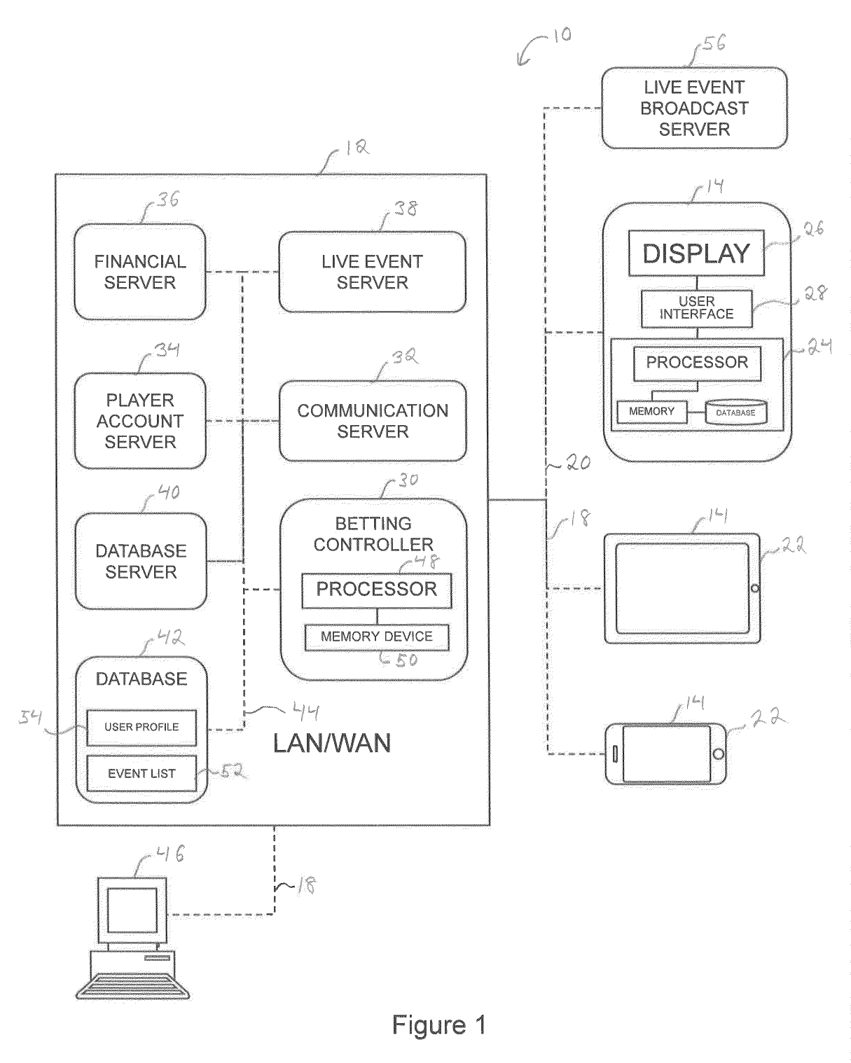

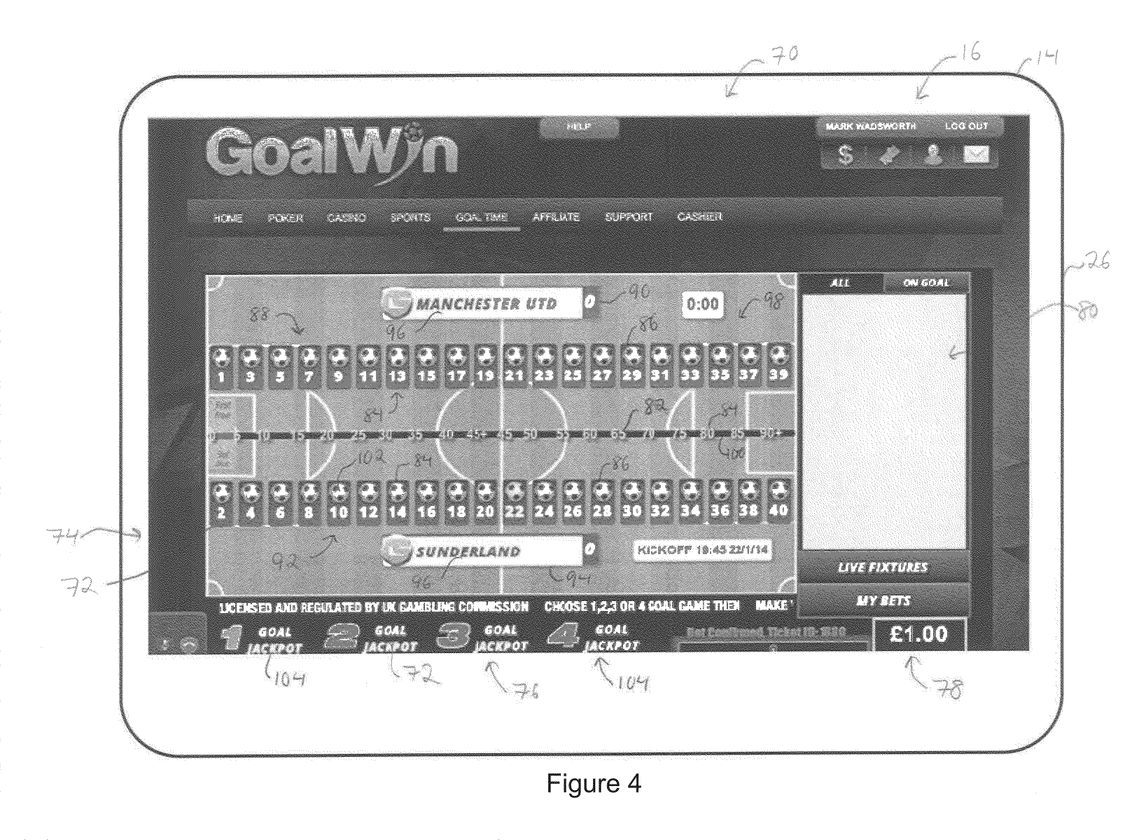

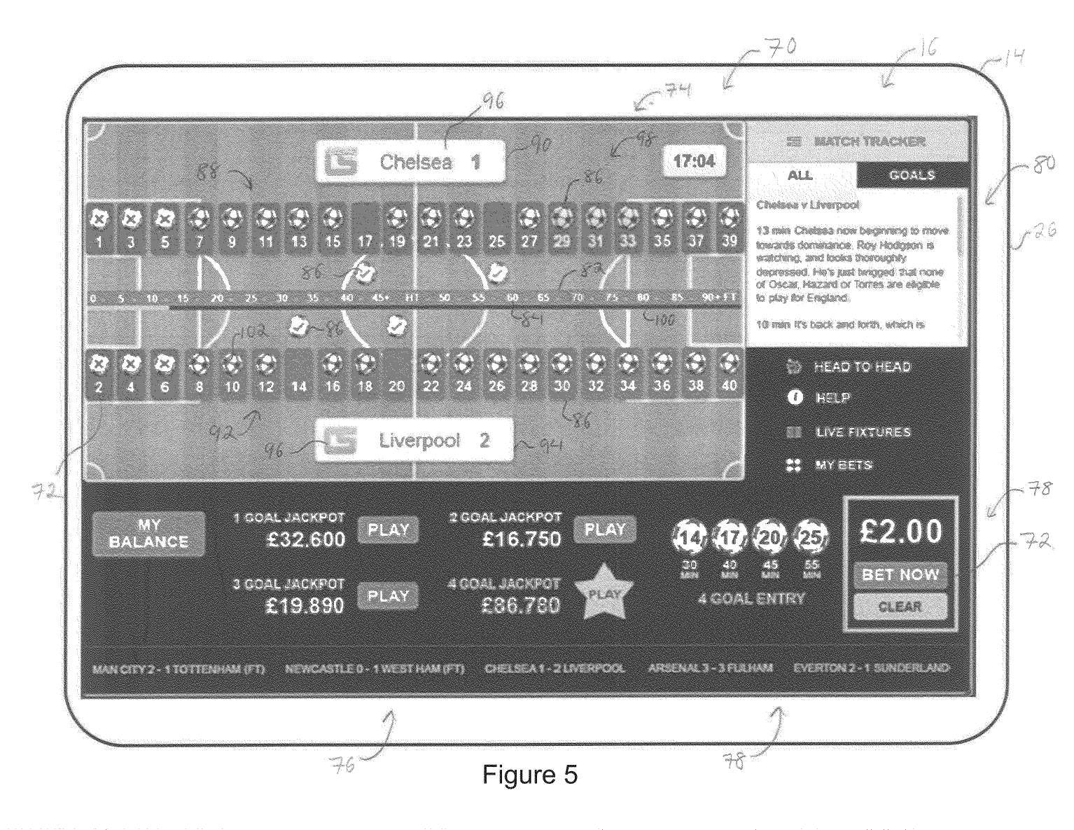

FIG. 1 is a schematic representation of the system 10, according to an embodiment of the invention. In the illustrated embodiment, the system 10 includes a server system 12 that is coupled to one or more user computing devices 14 to allow a plurality of players to simultaneously place wagers on a live sporting event. Each user computing device 14 is configured to transmit and receive data to and/or from the server system 12 to display graphical interfaces 16 (shown in FIGS. 4 and 5) to enable a user to generate one or more wagers on a plurality of event outcomes associated with a live sporting event via the user computing device 14. In the illustrated embodiment, the server system 12 is connected to each user computing device 14 via a communications link 18 that enables each user computing device 14 to access server system 12 over a network 20 such as, for example, the Internet, a cellular telecommunications network, a satellite communications network, a wireless network, a cable network, and/or any suitable telecommunication network that enables the user computing devices 14 to access the server system 12. For example, in one embodiment, the user computing device 14 includes a mobile computing device 22, e.g. a smartphone that communicates with the server system 12 via the cellular telecommunications network and/or the Internet. In another embodiment, the user computing device 14 may include a personal computer, laptop, cell phone, tablet computer, smartphone/tablet computer hybrid, personal/home video game device, personal data assistant, and/or any suitable computing device that enables a user to connect to the server system 12 and display the graphical interfaces 16.

In the illustrated embodiment, each user computing device 14 includes a controller 24 that is coupled to a display device 26 and a user input device 28. The controller 24 receives and transmits information to and from the server system 12 and displays the graphical interfaces 16 (shown in FIGS. 4 and 5) on the display device 26 to enable the user to interact with the server system 12 to place one or more wagers on a live sporting event in accordance with the embodiments described herein. The display device 26 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 28 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 24 and/or to retrieve data from the controller 24. Alternatively, a single component, such as a touch screen, a capacitive touch screen, and/or a touchless screen, may function as both the display device 26 and as the user input device 28.

In the illustrated embodiment, the server system 12 includes a betting controller 30, a communications server 32, a player account server 34, a financial server 36, a live event server 38, a database server 40, and a database 42 that are connected through a network 44 such as, for example, a local area network (LAN), a wide area network (WAN), dial-in-connections, cable modems, wireless modems, and/or special high-speed Integrated Services Digital Network (ISDN) lines. Moreover, at least one administrator workstation 46 is also connected to the network 44 to enable communication with the server system 12.

The communications server 32 communicates with the user computing devices 14 and the administrator workstation 46 to facilitate transmitting data over the network 20 via the Internet and/or the cellular network, respectively.

The database server 40 is connected to the database 42 to facilitate transmitting data to and from the database 42. The database 42 contains information on a variety of matters, such as, for example, account information related to a user, user profile information, sporting events, information indicative of sporting events, wagering event information, wager pools, total wagers associated with a wagering pool, total payout associated with a wager pool, wagers, wager amounts, and/or image data for producing wagering and event images and/or screens on the user computing device 14 and temporarily stores variables, parameters, and the like that are used by the betting controller 30.

The betting controller 30 includes a processor 48 and a memory device 50 that is coupled to the processor 48. The memory device 50 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 48 to store, retrieve, and/or execute instructions and/or data.

The processor 48 executes various programs, and thereby controls other components of the server system 12 and the user computing device 14 according to user instructions and data received from the user computing devices 14. The processor 48 in particular displays the graphical interfaces 16 (shown in FIGS. 4 and 5) and executes a wagering program, and thereby enables the system 10 to generate and display information associated with live sporting events including one or more wagering events, wagering opportunities, and/or sporting event outcomes associated with live sporting events and allow users to place one or more wagers on a plurality of wagering opportunities and/or event outcomes associated with the live sporting event in response to user instructions received via the user computing devices 14 in accordance with the embodiments described herein. The memory device 50 stores programs and information used by the processor 48. Moreover, the memory device 50 stores and retrieves information in the database 42 including, but not limited to, image data for producing images and/or screens on the display device 26, and temporarily stores variables, parameters, and the like that are used by the processor 48. In addition, the memory device 50 may store a sporting event list 52 that includes a plurality of sporting events that may be available to one or more players for use in placing wagers on one or more wagering opportunities associated with the live sporting events.

In the illustrated embodiment, the player account server 34 stores information associated with a plurality of user profile accounts and a plurality of corresponding unique user identifiers in a user profile program 54 in the database 42. In the illustrated embodiment, the player account server 34 uses the unique user identifier to identify the user profile account associated with the unique user identifier and provide the user access to the server system 12 to initiate a wagering session via a user computing device 14. In one embodiment, the unique user identifier may include a combination of a username and password. Alternatively, in another embodiment, the unique user identifier may include a personal identification number, or a random identification number assigned to a corresponding user account. For example, in one embodiment, the unique user identifier may include a mobile device identifier, such as, for example, a cellular phone number and/or wireless internet address for identifying a user computing device 14 associated with a user account.

In one embodiment, each user profile account may include personal identification information such as, for example, a user name, address, personal identification number, date of birth, email address, mobile phone number, IP address, URL, and/or any suitable information that enables the player account server 34 to identify a user. In addition, the user profile account may include bettor tracking information such as, for example, a collection of user-defined categories that are indicative of preferred wagering events. For example, in one embodiment, the user profile account may include a list of preferred sporting events, leagues, teams, sports, wagering opportunities, preferred event outcomes, and/or any suitable event category identified by the associated user.

The financial server 36 includes financial account information associated with each user profile account. More specifically, the financial server 36 includes a financial account and a wager account associated with each user profile account. Each financial account includes data that is indicative of financial information associated with a user profile. The financial information may include, but is limited to, available monetary funds for use in placing a wager, an available account balance, and/or any suitable financial information that enables the system 10 to function as described herein. The wager account includes information associated with each wager requested by the user including, but not limited to, a list of wagers made by the user, an wager amount associated with each wager, a list of active wagers, a list a past wagers made by the user, and/or any suitable information indicative of a wager.

During operation, the betting controller 30 receives a selection indicative of a wagering event from a user computing device 14 including an amount of a wager associated with the wagering event. For example, in one embodiment, the selected wagering event may include a request to select a number of wagering opportunities associated with a wagering pool. The betting controller 30 sends a verification message to the financial server 36 including a unique user identifier and an amount associated with the requested wager. The financial server 36 determines the financial account associated with the unique user identifier and determines if sufficient monetary funds are available in the user financial account determined as a function of the wager amount. If the financial server 36 determines sufficient funds are available in the user financial account, the financial server 36 sends a verification message to the betting controller 30 and deducts an amount from the user financial account equal to the amount of the wager. The financial server 36 creates a record of the requested wager including the wager amount deducted from the user financial account in the wager account. The betting controller 30 determines the outcome of the wager and provides an award to the user based on the wager outcome, and provides a credit to the user financial account that is equal to a payout amount associated with the wager.

The live event server 38 includes information associated with one or more live sporting events to facilitate allowing a user to place one or more wagers on the event outcomes of the live sporting event. The information may include, but not limited to, an event duration, one or more event outcomes associated with the live sporting event, teams and/or players participating in the sporting event, points, goals, penalties, fouls, runs, and/or any suitable information associated with a live sporting events. In the illustrated embodiment, the live event server 38 receives information associated with the live event and generates and stores the sporting event information in the database 42. In one embodiment, the live event server 38 may receive sporting event information from a live event broadcast server 56 via the network 20. The live event broadcast server 56 is configured broadcast information indicative of live sporting events.

In the illustrated embodiment, the workstation 46 includes a display and user input device to enable an administrative user to access the server system 12 to transmit data indicative of the wagering opportunities, payout awards, wagering events, wagers, and/or any suitable wagering and/or sporting event information to the database server 40. This enables an administrative user to periodically update available sporting events, an event list, wagering pools, wagering events, wagering opportunities, event time periods, event timeline, event outcomes, wager types, available awards, user profile accounts, and/or any suitable data and information that enables the system 10 to function as described herein.

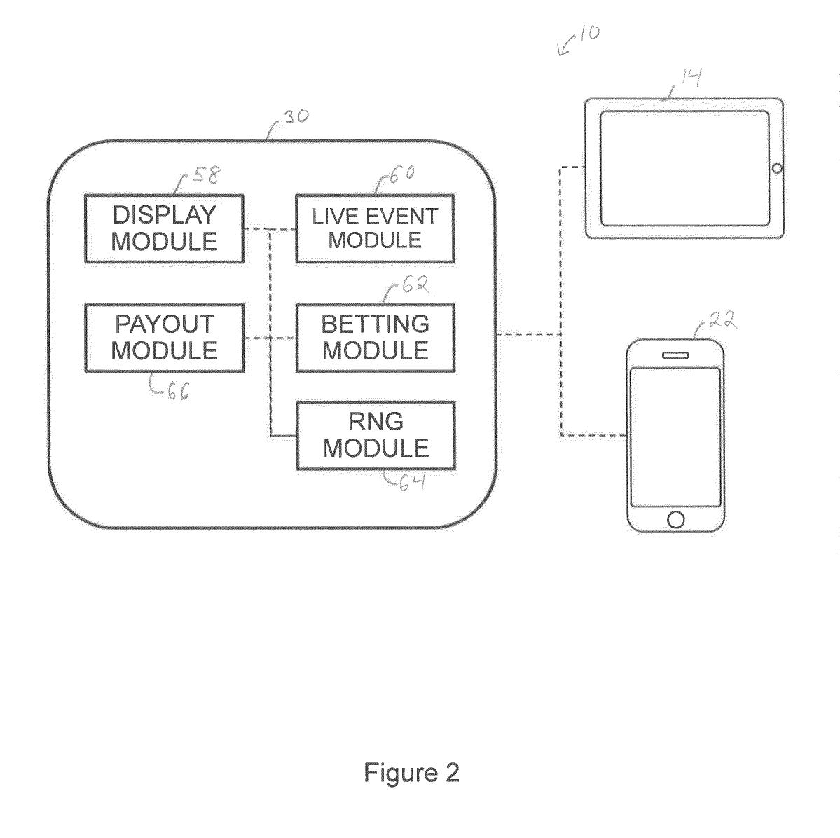

FIG. 2 is schematic view of the betting controller 30. In the illustrated embodiment, the betting controller 30 includes a display module 58, a live event module 60, a betting module 62, a random-number generator (RNG) module 64, and a payout module 66.

The display module 58 controls the display device 26 to display various images on the graphical interface 16 preferably by using computer graphics and image data stored in the database 42. In the illustrated embodiment, the display module 58 is configured to display a wagering screen 70 (shown in FIGS. 4 and 5) to display information and images associated with wagering events associated with a live sporting event to allow a player to place wagers before and during the live sporting event. The display module 58 may also displays a plurality of user selection areas 72 (shown in FIGS. 4 and 5) within the graphical interface 16 that correspond to specific operations that may be initiated by the user.

In the illustrated embodiment, the display module 58 displays the wagering screen 70 including a wagering area 74, a wagering pool area 76, a bet confirmation area 78, and an event information area 80. The display module 58 is configured to display an event timeline 82 associated with the live sporting event within the wagering area 74. In addition, the display module may also display a plurality of event time periods 84 within the wagering area 74 to allow a player to place a wager by selecting at least one event time period of the plurality of event time periods. In one embodiment, the display module 58 may display a plurality of betting slots 86 along the event timeline 82. Each betting slot 86 is indicative of an event outcome and an associated event time period 84, and may be selected by the player to be included in the requested wager. In addition, each betting slot 86 may be displayed with a corresponding identifying number being displayed in a sequential order to allow the player to easily distinguish a betting slot 86 being associated with an early portion of the event, e.g. a first half of a game, from a betting slot 86 being associated with a later portion of the event, e.g. a second half of the game. Moreover, the display module 58 may display a first group 88 of betting slots 86 that are associated with a first team 90 that is participating in the live sporting event, and display a second group 92 of betting slots 86 that are associated with a second team 94 that is participating in the live sporting event. In one embodiment, the display module 58 may display corresponding team images 96 with each of the first group 88 and the second group 92 to notify the player of the participating team being associated with the corresponding group of betting slots 86. Each team image 96 may include a team name and/or a team logo, and/or image and/or name of the competitors.

In the illustrated embodiment, the display module 58 displays an image of a playing field 98 that is indicative of the corresponding live sporting event, and displays the event timeline 82 along a longitudinal axis 100 of the playing field 98. In addition, the display module 58 may also display the first group of betting slots 86 at a position above the event timeline 82 and display the second group 92 of betting slots 86 at a position below the event timeline 82 to facilitate distinguishing the first group 88 from the second group 92. Moreover, in one embodiment, each of the first group 88 and the second group 92 of betting slots 86 are positioned a distance from the event timeline 82 to allow the player to visually distinguish between selected betting slots 86 and un-selected betting slots 86.

For example, the display module 58 may display a wagering event associated with a live football game, including displaying the corresponding event timeline 82 displayed across a football field. Each betting slot 86 is displayed along the event timeline 82 and positioned with respect to each corresponding event time period displayed with the event timeline 82. In addition, each betting slot 86 may be displayed with a symbol image 102 that is indicative of the corresponding event outcome to notify the player of the type of event outcome included in the wagering event. The symbol image 102 may include any suitable image to notify the player of the corresponding event outcomes associated with the wager and the live sporting event. As shown in FIGS. 4 and 5, if the event outcome is scored goals, the display module 58 may display an image of a football to notify the player that the corresponding event outcome includes a scored goal. In one embodiment, the display module 58 allows the player to select one or more betting slots 86 to be included in the wager, and responsively moves the selected betting slot 86 towards the event timeline 82 (as shown in FIG. 5) to notify the player of the selected betting slot 86.

In addition, as the live sporting event is being played, the display module 58 may modify an appearance of betting slots 86 that have expired because the associated event time periods correspond to periods that have lapsed due to the progress of the sporting event. For example, in the illustrated embodiment, as the live sporting event begins a second half of play, the display module 58 may modify the appearance of each betting slot 86 associated with the first half to notify the player of the progress of the live sporting event and the remaining betting slots 86 available for wagering.

In the illustrated embodiment, the display module 58 displays information associated with a plurality of available wagering pools 104 in the wagering pool area 76. The information associated with each wagering pool 104 may include, but is not limited to, a title, an amount of event outcomes included in the wagering pool 104, e.g. number of goals included in the pool, and a total payout amount associated with the wagering pool 104. The display module 58 allows a player to select one or more of the wagering pools 104 being displayed in the wagering pool area 76 for use in placing a wager associated with the selected wagering pool 104.

The display module 58 may also display the bet confirmation area 78 including information that is indicative of the wager being requested by the player. For example, in one embodiment, the display module 58 may display information associated with the selected wagering pool 104, selected betting slots 86 including the corresponding betting slot number and event period, and an amount of the wager.

The display module 58 may also display event information associated with the live sporting event in the event information area 80. The event information may include, but is not limited to, an audio/video feed image of the event, a current score, game statistics, a written update associated with the event broadcast, and/or any suitable event information associated with the live sporting event.

In the illustrated embodiment, the live event module 60 receives event information associated with the live sporting event from the live event server 38 including a duration of the live sporting event and displays the event information in the wagering area 74. Moreover, the live event module 60 determines an event timeline 82 as a function of the receive event information, and generates a plurality of event time periods 84 as function of the event timeline 82. Each of the event time periods 84 is indicative of a predefined period of time within the event timeline 82.

For example, the live event module 60 may receive information associated with a football match and generate an event timeline 82 including a first half period from the 00:00 minute to the 45:00 minute, first half extra time period, a second half period from the 45:00 minute to the 90:00 minute, and a second half extra time period. In addition, the live event module 60 selects a predefined duration of an event time period, and determines a number of event time periods 84 as a function of the predefined duration and the event timeline 82. For example, the live event module 60 may select the predefined duration to be 5 minutes, and determine each event time period 84 to include a 5-minute increment. The live event module 60 calculates the number of event time periods 84 that may be included in the wagering event as a function of the duration of the sporting event and the event timeline 82. For example, as shown in FIG. 4, the live event module 60 may determine that 9 event time periods 84, each having a 5-minute duration, may be included in the first half of the match, e.g. 45 minutes divided by 5 minutes, and 9 event time periods 84 may be included in the second half of the match, e.g. 45 minutes divided by 5 minutes. In addition, the live event module 60 may also assign an event time period to each of the extra time periods to account for the unknown duration of time included in the first and second half extra time periods.

In the illustrated embodiment, the betting module 62 selects an event outcome occurring during the live sporting event and generates a plurality of betting slots 86 as function of the event time periods 84 and the selected event outcome. The betting module 62 also assigns each of the betting slots 86 to each of the event time periods 84. For example, as shown in FIGS. 4 and 5, in one embodiment, the betting module 62 may select an event outcome indicative of a goal in a football match, and generates each betting slot 86 being indicative of a goal being scored within the corresponding event time period 84 associated with the betting slot 86. In addition, in one embodiment, the betting module 62 may generate a first group 88 of betting slots 86 associated with a first team 90 and/or first competitor, and generate a second group 92 of betting slots 86 being associated with a second team 94 and/or second competitor. The first group 88 of betting slots 86 being indicative of the first team 90 scoring a goal within a corresponding event time period 84, and the second group 92 of betting slots 86 being indicative of the second team 94 scoring a goal within a corresponding event time period 84.

In the illustrated embodiment, the betting module 62 is configured to receive a request from a player including a selection of one or more betting slots 86 and generate the wager in response to the received request. In addition, the betting module 62 may allow a player to select a wagering pools 104, determines a number of event outcomes associated with the wagering pool 104 and allows the player to select a corresponding number of betting slots 86 to be associated with the wager. For example, if the player selects a 4-goal jackpot wagering pool, as shown in FIG. 4, the betting module 62 allows the player to select four betting slots 86 corresponding to the number of event outcomes, e.g. goals, that are included in the 4-goal jackpot wagering pool. In the illustrated embodiment the betting module 62 receives result information from the live event module 60 indicative of an outcome of the live sporting event and settles each wager received from the participating player by either awarding a payout amount if the selected event outcome associated with the betting slots 86 occurred during the selected event time period or collecting the wager.

In addition, the betting module 62 communicates with the player account server 34 and the financial server 36 to manage the amount of player's betting credits and/or monetary funds available for use in placing wagers on the live sporting events. In the illustrated embodiment, the betting module 62 receives a user selection indicative of a request from a user computing device 14 to place a wager including an amount of wagering credits and/or monetary funds to be placed with the wager. The betting module 62 sends a verification message to the financial server 36 including a unique user identifier and a monetary amount associated with the requested wager. The financial server 36 identifies the user profile account associated with the unique user identifier and determines if sufficient funds are available in the user profile account as a function of the user request. If the financial server 36 determines sufficient funds are available in the user profile account, the financial server 36 sends a verification message to the betting module 62 and withdraws a corresponding amount of funds from the user profile account. If the financial server 36 determines that the user profile account does not include a sufficient amount of funds, the display module 58 may display a message on the user computing device 14 requesting the user to deposit additional funds corresponding to the request.

The RNG module 64 generates and outputs random numbers to the betting module 62 for use in generating wagers. In addition, the betting module 62 may use random numbers generated by the RNG module 64 to select one or more betting slots 86 to be assigned to a wager. For example, in one embodiment, the upon receiving a wager request from a player, the betting module 62 may provide a selection option to the player including 1) the player selects each betting slot 86 to be associated with the wager; or 2) each betting slot 86 is randomly selected by the betting module 62. If the player requests the betting module 62 to randomly select each of the betting slots 86 being included in the wager, the betting module 62 uses the RNG module 64 to randomly select one or more betting slots 86 to be included in player's wager.

In the illustrated embodiment, the payout module 66 receives information associated with the monetary value of each wager generated by the betting module 62 and generates and stores the wager value in the database 42. In addition, the payout module 66 generates a total payout amount available to each of the participating players as a function of each received wager value. In the illustrated embodiment, the payout module 66 established a plurality of wagering pools 104 that may be selected by a player. Each wagering pool 104 may be associated with a predefine number of wagering opportunities. For example, in one embodiment, the payout module 66 may generate a 1-goal wagering pool, a 2-goal wagering pool, a 3-goal wagering pool and/or a 4-goal wagering pool. The 1-goal wagering pool allows players to wager on one goal occurring during a football match and to select one betting slot 86 to be associated with the wager. The 2-goal wagering pool allows players to wager on two goals occurring during the match and to select two betting slots 86 to be included in the wager. The 3-goal wagering pool allows players to wager on three goals occurring during an event and to select three betting slots to be included in the wager. The 4-goal wagering pool allows players to wager on four goals occurring during an event and to select four betting slots to be included in the wager. In the illustrated embodiment, the payout module 66 generates a jackpot pool account associated with each wagering pool 104 and stores each wager value associated with the corresponding wagering pool in the corresponding jackpot pool account. In addition, the payout module 66 provides an award payout to each winning player based on the received wager and the corresponding wagering pool jackpot pool account.

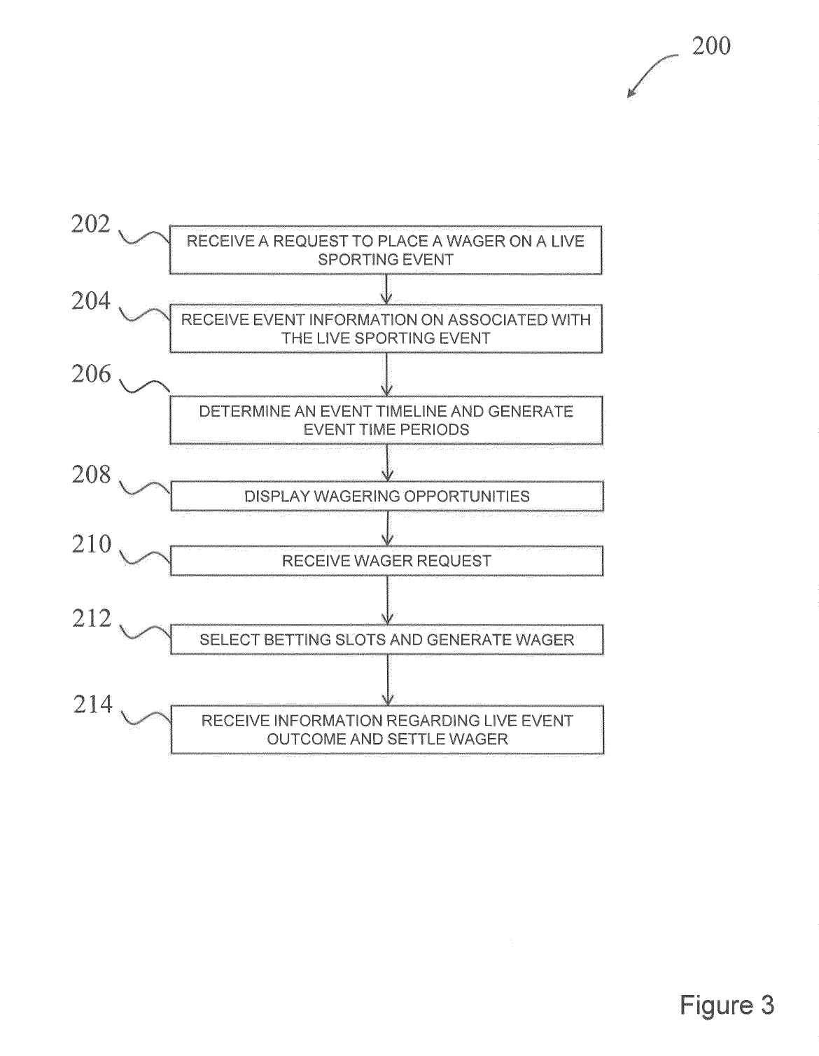

FIG. 3 is a flowchart of a method 200 that may be used with the system 10 for allowing a player to place a wager on live sporting events. Each method step may be performed independently of, or in combination with, other method steps. Portions of the method 200 may be performed by any one of, or any combination of, the components of the system 10. FIGS. 4 and 5 are exemplary entertaining graphical displays of a wagering screen 70 that may be displayed by the system 10. In the illustrated embodiment, entertaining graphical displays for amusement purposes are presented by the user computing device 14 via the display device 26 (shown in FIG. 1) and may receive input (e.g., selections and/or entries) via the user input device 28 (shown in FIG. 1). For example, in one embodiment, a selection may be received via the user input device 28 of the user computing device 14 and may be transmitted by the user computing device 14 to the server system 12 via the network 20.

In the illustrated embodiment, in the method step 202, the betting controller 30 receives a request from a player to place a wager on a live sporting event from a user computing device 14 and displays the wagering screen 70 on the display device 26 for use by the player. In one embodiment, the player may submit the request by accessing a website via the communications server 32. In another embodiment, the player may access a mobile website via a cellular network. In addition, in one embodiment, the method step 202 may include receiving, by the betting controller 30, a unique user identifier to validate the request to place a wager. More specifically, the display module 58 may display a login screen (not shown) on the user computing device 14 to request the unique user identifier such as, for example, requesting a username and/or password. The betting controller 30 may receive the unique user identifier and transmit a validation request including the user credentials to the player account server 34. The player account server 34 may compare the received unique user identifier with the collection of unique user identifier contained in the user profile program to validate the unique user identifier and responsively send a validation message to the betting controller 30 if the received unique user identifier is included in the user profile program. Upon receiving the validation message from the player account server 34 the betting controller 30 may display the wagering screen 70. In addition, in one embodiment, if the received user identifier is not included in the user profile program 54, the betting controller 30 may prompt the user to establish a user account and/or display the wagering screen 70 without requiring the user to establish a user account and/or verify a user account.

In method step 204, the betting controller 30 receives event information associated with a live sporting event in response to the received request. In one embodiment, the betting controller 30 receives event information including a duration of the live sporting event. In method step 206, the betting controller 30 determines an event timeline 82 as a function of the receive event information and generates a plurality of event time periods 84 as function of the event timeline 82. Each of the event time periods 84 may be indicative of a predefined period of time within the event timeline. The betting controller 30 may also display the plurality of event time periods on the display device to allow the participating player to place a wager by selecting at least one event time period of the plurality of event time periods.

In method step 208, the betting controller 30 may display at least one wagering opportunity on a display device 26. The wagering opportunity may be indicative of an event outcome occurring in the live sporting event in the future within a particular event time period of the live sporting event. The betting controller 30 may also generate a plurality of betting slots 86 included in the wagering opportunity. Each of the betting slots 86 may be indicative of each of the plurality of event time periods. During method step 208, the betting controller 30 may also display the event timeline on the display device and displaying each of the plurality of betting slots with respect to the event timeline, each betting slot of the plurality of betting slots being orientated with respect to a corresponding event time period along the event timeline. In one embodiment, the betting controller 30 may generate a first group of betting slots associated with a first team participating in the live sporting event, generate a second group of betting slots associated with a second team participating in the live sporting event, and displaying the first and the second groups of betting slots along the event timeline.

In method step 210, the betting controller 30 receives a wager request to place a wager from a participating user including at least one selected event outcome and event time period in which the selected event outcome will occur. In one embodiment, during method step 210, the betting controller 30 may generate a plurality of betting pools being assigned a number of event outcomes, receive the request to place a wager including a corresponding number of event outcomes, and assign the wager request to one of the plurality of betting pools in response to the corresponding number of event outcomes included in the wager request.

In method step 212, the betting controller 30 allows the player to select one or more betting slots 86 and responsively generates the wager in response to the wager request. In one embodiment, the betting module 62 may randomly select one or more betting slots 86 to be include in the wager. During method step 212, the betting controller 30 may select a number of event outcomes occurring during the live sporting event in response to the received request, select a plurality of event time periods associated with each of the selected number of event outcomes, and generate the wager as a function of the selected number of event outcomes and the selected plurality of event periods. During method step 212, betting controller 30 may also randomly select each of the plurality of event time periods and assigning each of the number of event outcomes to each of the randomly selected event time periods.

In one embodiment, during method step 212, the betting controller 30 may determine if the wager request is received during play of the live sporting event. In addition, the betting controller 30 may determine a current elapse time of the live sporting event, determine a period of time from the current elapse time to the selected event time period, and responsively generating the wager if the determined period of time is larger than a predefined period of time.

In method step 214, the betting controller 30 receives information regarding the selected event time period of the live sporting event, determines if the at least one selected event outcome occurred during the selected event time period, and settles the wager received from the participating player by either awarding a payout amount if the selected event outcome occurred during the selected event time period or collecting the wager.

In one embodiment, during method step 214, the betting controller 30 may detect a number of event outcomes occurring in the live sporting event and award a payout amount to the participating player if the detected number of event outcomes occurring during the live sporting event matches the selected number of event outcomes. In addition, the betting controller 30 may determine if each event time period associated with each detected event outcome matches a selected event time period and award a payout amount to the participating player if detected event outcome occurs during a matching selected event time period.

In one embodiment, the system 10 includes a gaming platform configured to provide a live, in-game pool (pari-mutuel) betting service. The system 10 is designed to accept bets during live Football and other sporting events. The system 10 is configured to generate a game card (shown in FIGS. 4 and 5) that includes a number of possible selections or ‘slots’ 86. Each slot 86 represents a pre-defined 5 minute time slot associated with a live sporting event. For example, if the live sporting event includes a football game, the system 10 may generate 40 slots 86, with each slot 86 representing a 5 minute period of the game. For example, slots 1 to 18 may represent the first half 00:00 minute to the 45:00 minute, slots 19 and 20 may represent first half, extra time from 45:01 minute to until the first half whistle is blown, slots 21 to 38 may represent second half from the 45:00 minute to the 90:00 minute (end of regulation), and slots 39 and 40 may represent second half, extra time from the 90:01 minute to until the final whistle is blown (eng of football game). In addition, the betting timeslots for football may represented as follows: slot 1 is the 00:00 to the 04:59 minute for the home team, slot 2 is the 00:00 minute to the 04:59 minute for the away team, slot 3 is the 05:00 minute to the 09:59 minute for the home team, the slot 4 is the 05:00 minute to the 09:59 minute for the away team, . . . slot 19 is the first half added time for the home team, and slot 20 is the first half added time for the away team, . . . slot 39 is the second half added time for the home team, and slot 40 is the second half added time for the away team.

In one embodiment, the system 10 may also generate a plurality of jackpot pools 104. Jackpots 104 may be pooled in to either 1, 2, 3 or 4 goal combinations depending on the type of bet placed. For example, 1 Goal Jackpot Game, 2 Goal Jackpot Game, 3 Goal Jackpot Game, and 4 Goal Jackpot Game. Each bet is made up of a selection of an amount of slot numbers from 1 to 4. The number of slot numbers selected relates directly to the game being played, for example, one selected slot number includes a bet placed on the 1 Goal Jackpot game, two selected slot numbers includes a bet placed on the 2 Goal Jackpot game, three selected slot numbers includes a bet placed on the 3 Goal Jackpot game, and four selected slot numbers includes a bet placed on the 4 Goal Jackpot game.

In the case where there are no winners from each of the types of jackpots, then that Jackpot will rollover to the next game.

During a 1 Goal Jackpot Game, the system 10 allows one or more players to place a single bet by selecting one number slot 86, for example, slot #7. Slot #7 represents the time between 15:00 and 19:59 in the first half for the home team. If a goal is scored in the selected slot, then the player wins a share of the 1 Goal Jackpot. If one or more goals are scored in the selected match, each player who has a winning slot/goal will get an equal share of the 1 Goal jackpot. If there are goals associated with slots #7, #12 and #21, then each player who has a 1 goal entry with any of those numbers will win a share of the 1 Goal Jackpot, e.g. Player 1 selecting slot #7 is a winning bet, Player 2 selecting slot #12 is a winning bet, and Player 3 selecting slot #21 is a winning bet. If there are no goals or no matching tickets then the 1 goal pool will rollover to the next 1 Goal Jackpot game.

During a 2 Goal Jackpot Game, the system 10 allows one or more players to place a single bet by selecting two individual slots 86, for example, slot #7 and slot #18. Slot #7 represents the time between 15:00 and 19:59 in the first half for the home team. Slot #18 represents the time between 40:00 and 44:59 in the first half for the away team. If a goal is scored in both of the corresponding slots, i.e. slot #7 and Slot #18, then the player wins a share of the 2 Goal Jackpot. If two or more goals are scored in the selected match, then each player that has selected 2 winning slots with a single ticket entry will win an equal share of the 2 Goal Jackpot. For example, if there are goals associated with slots #7, #18 and #21, then each player who has a 2 goal entry with any of those numbers will win a share of the 2 Goal Jackpot, e.g. Player 1 selecting slot #7 and slot #18 is a winning bet, Player 2 selecting slot #7 and slot #21 is a winning bet, and Player 3 selecting slot #18 and slot #21 is a winning bet. If there are less than two goals or no matching tickets then the 2 Goal Jackpot will rollover to the next 2 Goal Jackpot game.

During a 3 Goal Jackpot Game, the system 10 allows one or more players make a single bet by selecting three individual slot numbers, for example, slot #7, slot #18, and slot #21. Slot #7 represents the time between 15:00 and 19:59 in the first half for the home team, slot #18 represents the time between 40:00 and 44:59 in the first half for the away team, and slot #21 represents the time between 45:00 and 49:59 in the second half for the home team. If a goal is scored in all 3 of the corresponding slots, then the player wins an equal share of the 3 Goal Jackpot. If three or more goals are scored in the selected match, then each player that has selected 3 winning slots with a single ticket entry will win an equal share of the 3 Goal jackpot. For example, if there are goals associated with in slots #7, #18, #21 and #29 then each player who has a 3 goal entry with any of those numbers will win a share of the 3 Goal Jackpot, e.g. Player 1 selecting slots #7, slot #18, and slot #21 is a winning bet, Player 2 selecting slots #7, #21 and #29 is a winning bet, and Player 3 selecting slots #18, #21, and #29 is a winning bet. If there are less than three goals or no matching tickets then the 3 Goal Jackpot will rollover to the next 3 Goal Jackpot game.

During a 4 Goal Jackpot Game, the system 10 allows the players place a single bet by selecting four individual numbers, for example, slot #7, slot #18, slot #21, and slot #29. Slot #7 represents the time between 15:00 and 19:59 in the first half for the home team, slot #18 represents the time between 40:00 and 44:59 in the first half for the away team, slot #21 represents the time between 45:00 and 49:59 in the second half for the home team, and slot #29 represents the time between 65:00 and 69:59 in the second half for the home team. If a goal is scored in all 4 of the corresponding slots, then the player wins an equal share of the 4 Goal Jackpot. If four or more goals are scored in the selected match, then each player that has selected 4 winning slots with a single ticket entry will get an equal share of the 4 Goal jackpot. For example, if there are goals in slots #7, #18, #21, #29, and #36 then each player who has a 4 goal entry with any of those numbers will win a share of the 4 Goal Jackpot, e.g. Player 1 selecting slots #7, #18, #21, and #29 is a winning bet, Player 2 selecting slots #7, #21, #29, and #36 is a winning bet, and Player 3 selecting slots #18, #21, #29, and #36 is a winning bet. If there are less than four goals or no matching tickets then the 4 Goal Jackpot will rollover.

Betting Time Constraints. In one embodiment, the system 10 may allow a player to place a bet on a match either before the game starts or live during the game itself, up to 20 seconds before the start of an actual bet slot. For example, the system 10 may allow a player to bet on slot #3 (05:00 to 9:59 for the home team) if the corresponding bet is placed and confirmed by the system before 04:40 minutes into the game.

Pool allocation and Pay-outs. In one embodiment, the system 10 may generate the award pools as follows: 70% of the total pool amount being allocated to the pool jackpot awards and rollovers (where either jackpot is not paid out during a specific game) may be carried over and added to the jackpots of future games. All jackpots that are seeded by the system 10 (jackpots that are offered but not necessarily generated through player funds) may be deposited in a dedicated jackpot bank or covered by an appropriate insurance policy.

Large wins will be manually verified by the Operator, Service Provider and Data Provider before being paid out. Additional KYC may be performed in the case of large wins.

Data Provider. All data for the game, including: Goals, Times of goals, Who scored the goal, What team, Penalties, Yellow and red cards, Substitution, Corners, and/or Free Kicks, are provided by an official data provider.

Match Fixing. The system 10 may be configured to monitor betting volume to detect match-fixing, either as a result of the size or volume of bets received, or from other evidence, or where the integrity of an individual event is called to question. The system 10 may withhold payment and ultimately to declare bets on that event void.

Postponed Games. In the case of a postponed game bets are valid at the time the game fixture is played. It is the same game, different time and date. However, a business decision might overturn this and bets returned.

Abandoned Games. In the case of an abandoned game, all bets will be returned to the player for the game that is abandoned.

Data Feed Dies. If the game is still active when the data feed dies, the Service Provider will manually enter the team, goal, and time manually.

System Failure. In the event that any part of the system fails, meaning that bets cannot be placed, viewed, the game client is not available due to technical difficulties suffered by the data provider of system 10, all bets will be void for the games that are set to play in the time that the system(s) failed. Jackpots will be reset to their previous state before the game would have started.

It should be understood that methods or systems such as those described herein may be adapted and configured to function independently or may also interact with other systems or applications, such as for example, a casino management system or player tracking system.

Those skilled in the art will readily appreciate that any of the systems and methods of the invention may include various computer and network related software and hardware, such as programs, operating systems, memory storage devices, data input/output devices, data processors, servers with links to data communication systems, wireless or otherwise, and data transceiving terminals, and may be provided on a standalone device, kiosk or incorporated in another platform, such as a mobile device. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

It should be understood that the aforementioned embodiments of the invention may be incorporated in a fully or partially automated or interactive, computerized platform supporting multiple player positions and wagering according to the invention. It should be readily apparent that additional computerized or manual systems may also be employed in accordance with the invention in order to achieve its full implementation as a system, apparatus or method.

While exemplary systems and methods, and applications of methods of the invention, have been described herein, it should also be understood that the foregoing and the attached materials, which describe a non-limiting exemplary embodiment of the invention, are only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein and in the attached materials, including any equivalents thereto.

Exemplary embodiments of a system and method of allowing a user to place a wager via a mobile computing device are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A system for providing a wagering game to a user via a computing device, comprising:
a database including information associated with a live sporting event; and
a controller coupled in communication with the database and the computing device, the controller configured to:
display at least one wagering opportunity on the computing device, the at least one wagering opportunity being indicative of an event outcome occurring in the live sporting event in the future within a particular event time period of the live sporting event;
receive a wager request to place a wager from a participating user, the wager being associated with at least one selected event outcome and event time period in which the selected event outcome will occur, and responsively generate the wager;
receive information regarding the selected event time period of the live sporting event;
determine if the at least one selected event outcome occurred during the selected event time period; and
settle the wager received from the participating player by either awarding a payout amount if the selected event outcome occurred during the selected event time period or collecting the wager.

2. A system in accordance with claim 1, the controller configured to:
receive event information associated with the live sporting event in response to the received request, the event information including a duration of the live sporting event;
determine an event timeline as a function of the receive event information;
generate a plurality of event time periods as function of the event timeline, each of the event time periods being indicative of a predefined period of time within the event timeline; and
display the plurality of event time periods on the computing device to allow the participating player to place a wager by selecting at least one event time period of the plurality of event time periods.

3. A system in accordance with claim 2, the controller configured to:
determine if the wager request is received during play of the live sporting event;
determine a current elapse time of the live sporting event;
determine a period of time from the current elapse time to the selected event time period; and
responsively generate the wager if the determined period of time is larger than a predefined period of time.

4. A system in accordance with claim 2, the controller configured to:
generate a plurality of betting slots, each of the betting slots being indicative of each of the plurality of event time periods;
display the event timeline on the computing device; and
display each of the plurality of betting slots with respect to the event timeline, each betting slot of the plurality of betting slots being orientated with respect to a corresponding event time period along the event timeline.

5. A system in accordance with claim 4, the controller configured to:
generate a first group of betting slots associated with a first team participating in the live sporting event;
generate a second group of betting slots associated with a second team participating in the live sporting event; and
display the first and the second groups of betting slots along the event timeline.

6. A system in accordance with claim 2, the controller configured to:
select a number of event outcomes occurring during the live sporting event in response to the received request;
select a plurality of event time periods, each of the plurality of event time periods being associated with each of the selected number of event outcomes; and
generate the wager as a function of the selected number of event outcomes and the selected plurality of event periods.

7. A system in accordance with claim 1, the controller configured to:
generate a plurality of betting pools, each betting pool being assigned a number of event outcomes, at least one of the betting pools having a different number of event outcomes than another betting pool;
receive the request to place a wager including a corresponding number of event outcomes; and
assign the wager request to one of the plurality of betting pools in response to the corresponding number of event outcomes included in the wager request.

8. A method for providing a wagering game to a user, including the steps of:
displaying at least one wagering opportunity on a computing device, the at least one wagering opportunity being indicative of an event outcome occurring in the live sporting event in the future within a particular event time period of the live sporting event;
receiving a wager request to place a wager from a participating user, the wager being associated with at least one selected event outcome and event time period in which the selected event outcome will occur, and responsively generating the wager;
receiving information regarding the selected event time period of the live sporting event;
determining if the at least one selected event outcome occurred during the selected event time period; and
settling the wager received from the participating player by either awarding a payout amount if the selected event outcome occurred during the selected event time period or collecting the wager.

9. A method in accordance with claim 8, including the steps of:
receiving event information associated with the live sporting event in response to the received request, the event information including a duration of the live sporting event;
determining an event timeline as a function of the receive event information;
generating a plurality of event time periods as function of the event timeline, each of the event time periods being indicative of a predefined period of time within the event timeline; and
displaying the plurality of event time periods on the computing device to allow the participating player to place a wager by selecting at least one event time period of the plurality of event time periods.

10. A method in accordance with claim 9, including the steps of:
determining if the wager request is received during play of the live sporting event;
determining a current elapse time of the live sporting event;
determining a period of time from the current elapse time to the selected event time period; and
responsively generating the wager if the determined period of time is larger than a predefined period of time.

11. A method in accordance with claim 9, including the steps of:
generating a plurality of betting slots, each of the betting slots being indicative of each of the plurality of event time periods;
displaying the event timeline on the computing device; and
displaying each of the plurality of betting slots with respect to the event timeline, each betting slot of the plurality of betting slots being orientated with respect to a corresponding event time period along the event timeline.

12. A method in accordance with claim 11, including the steps of:
generating a first group of betting slots associated with a first team participating in the live sporting event;
generating a second group of betting slots associated with a second team participating in the live sporting event; and
displaying the first and the second groups of betting slots along the event timeline.

13. A method in accordance with claim 9, including the steps of:
selecting a number of event outcomes occurring during the live sporting event in response to the received request;
selecting a plurality of event time periods, each of the plurality of event time periods being associated with each of the selected number of event outcomes; and
generating the wager as a function of the selected number of event outcomes and the selected plurality of event periods.

14. A method in accordance with claim 9, including the steps of:
generate a plurality of betting pools, each betting pool being assigned a number of event outcomes, at least one of the betting pools having a different number of event outcomes than another betting pool;
receiving the request to place a wager including a corresponding number of event outcomes; and
assigning the wager request to one of the plurality of betting pools in response to the corresponding number of event outcomes included in the wager request.

15. One or more non-transitory computer-readable storage media, having computer-executable instructions embodied thereon, wherein when executed by at least one processor, the computer-executable instructions cause the processor to:
display at least one wagering opportunity on a computing device, the at least one wagering opportunity being indicative of an event outcome occurring in the live sporting event in the future within a particular event time period of the live sporting event;
receive a wager request to place a wager from a participating user, the wager being associated with at least one selected event outcome and event time period in which the selected event outcome will occur, and responsively generate the wager;
receive information regarding the selected event time period of the live sporting event;
determine if the at least one selected event outcome occurred during the selected event time period; and
settle the wager received from the participating player by either awarding a payout amount if the selected event outcome occurred during the selected event time period or collecting the wager.

16. The one or more computer-readable storage media according to claim 15, wherein when executed by at least one processor, the computer-executable instructions cause the processor to:
receive event information associated with the live sporting event in response to the received request, the event information including a duration of the live sporting event;
determine an event timeline as a function of the receive event information;
generate a plurality of event time periods as function of the event timeline, each of the event time periods being indicative of a predefined period of time within the event timeline; and
display the plurality of event time periods on the computing device to allow the participating player to place a wager by selecting at least one event time period of the plurality of event time periods.

17. The one or more computer-readable storage media according to claim 16, wherein when executed by at least one processor, the computer-executable instructions cause the processor to:
determine if the wager request is received during play of the live sporting event;
determine a current elapse time of the live sporting event;
determine a period of time from the current elapse time to the selected event time period; and
responsively generate the wager if the determined period of time is larger than a predefined period of time.

18. The one or more computer-readable storage media according to claim 16, wherein when executed by at least one processor, the computer-executable instructions cause the processor to:
generate a plurality of betting slots, each of the betting slots being indicative of each of the plurality of event time periods;
display the event timeline on the computing device; and
display each of the plurality of betting slots with respect to the event timeline, each betting slot of the plurality of betting slots being orientated with respect to a corresponding event time period along the event timeline.

19. The one or more computer-readable storage media according to claim 18, wherein when executed by at least one processor, the computer-executable instructions cause the processor to:
generate a first group of betting slots associated with a first team participating in the live sporting event;
generate a second group of betting slots associated with a second team participating in the live sporting event; and
display the first and the second groups of betting slots along the event timeline.

20. The one or more computer-readable storage media according to claim 15, wherein when executed by at least one processor, the computer-executable instructions cause the processor to:
generate a plurality of betting pools, each betting pool being assigned a number of event outcomes, at least one of the betting pools having a different number of event outcomes than another betting pool;
receive the request to place a wager including a corresponding number of event outcomes; and
assign the wager request to one of the plurality of betting pools in response to the corresponding number of event outcomes included in the wager request.
